(19) United States
(12) Patent Application Publication
(10) Pub. No.: US 2002/0061377 A1
(43) Pub. Date: May 23, 2002

(54) Multilayer pipe

(75) Inventor: Janos Kertesz, Hofheim (DE)

Correspondence Address: Friedrich Kueffner, Suite 1921, 342 Madison Avenue, New York, NY, 10173, US

(73) Assignee: Rasmussen GmbH

(21) Appl. No.: 10/002,931

(22) Filed: Nov. 15, 2001

(30) Foreign Application Priority Data
Nov. 23, 2000 (DE) 100 57 990.6

(51) Int. Cl. B32B 1/08

(52) U.S. Cl. 428/36.91

(57) ABSTRACT

A multilayer pipe is composed of at least three layers, wherein at least two of the layers are based on thermoplastic polyester, one layer is harder than the other layers, at least one of the other layers contains a thermoplastic polyesterelastomer. For preventing brittling of the material of the multilayer pipe, the radially innermost contains at least one of the materials polyolefin, polyolefin copolymer, polyolefin terpolymer, grafted polyolefin and polyamid, and at least one of the layers is modified against thermal aging.

### BACKGROUND OF THE INVENTION

1. Field of the Invention

The present invention relates to a multilayer pipe having at least three layers, wherein at least two of the layers are based on thermoplastic polyester, one of the layers is harder than the other layers, and at least one of the other layers contains a thermoplastic polyester elastomer.

2. Description of the Related Art

A multilayer pipe of the above-described type is disclosed in U.S. Pat. No. 6,294,234 B1. Such a multilayer pipe has the advantage that the combination of its materials not only meets the major requirements in the filed of fuel and fuel vapor conduits, such as low fuel permeation, high bending capability, extensibility, impact strength, and resistance to chemicals in motor vehicles, but also are connected together by fusion when subjected to a hot forming treatment. However, it has been found that the innermost layer of such a multilayer pipe hydrolytically decomposes and becomes brittle if it comes for a longer period of time in contact with a liquid fuel, particularly motor vehicle fuel, which contains water and/or alcohol at higher temperatures.

### SUMMARY OF THE INVENTION

Therefore, it is the primary object of the present invention to provide a multilayer pipe of the above-described type in which the long-term elasticity and flexibility is maintained even at higher temperatures of up to at least 90° C. when coming into contact with a liquid fuel or fuel vapors.

In accordance with the present invention, this object is met in a multilayer pipe in which the radially innermost layer contains at least one of the materials polyolefin, polyolefin copolymer, polyolefin terpolymer, grafted polyolefin and polyamid, and at least one of the layers is modified against thermal aging.

As a result of the configuration according to the present invention, when the innermost layer comes into contact with a fuel, such as gasoline for spark ignition engines, this innermost layer prevents a premature brittling of the material of that layer to whose inner side the innermost layer is attached. This is because, if the innermost layer is attached to a polyester layer, the end groups of the polyester and the material of the innermost layer, such as olefin or olefin copolymer react with each other, so that a compound is created which increases the long-term elasticity and flexibility of the polyester even at higher temperatures of up to at least 90° C.

The thermoplastic polyesterelastomer preferably is a thermoplastic etheresterelastomer (TEEE). This material is softer than the harder polyester and has higher flexibility and elasticity. Consequently, it has a higher impact strength, also at temperatures below 0° C.

The polyester may contain at least one of the materials polybutyleneterephthalate (PBT), polyethyleneterephthalate (PET), polybutylene-naphthalate (PBN) and polyethylenenaphthalate (PEN).

The radially outermost layer may also contain at least one of the materials polyolefin, polyolefin copolymer, polyolefin terpolymer, grafted polyolefin and polyamid. This also prevents brittling of the layer located underneath the outermost layer which is otherwise exposed and may come into contact with fuel.

In addition, one of the layers, especially the radially innermost layer, should contain an electrically conductive additive which prevents an electrostatic charging of the multilayer pipe.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIGS. 1 to 7 of the drawing each show a partial sectional view in axial direction of an embodiment of the multilayer pipe according to the present invention.

### DESCRIPTION OF THE PREFERRED EMBODIMENTS

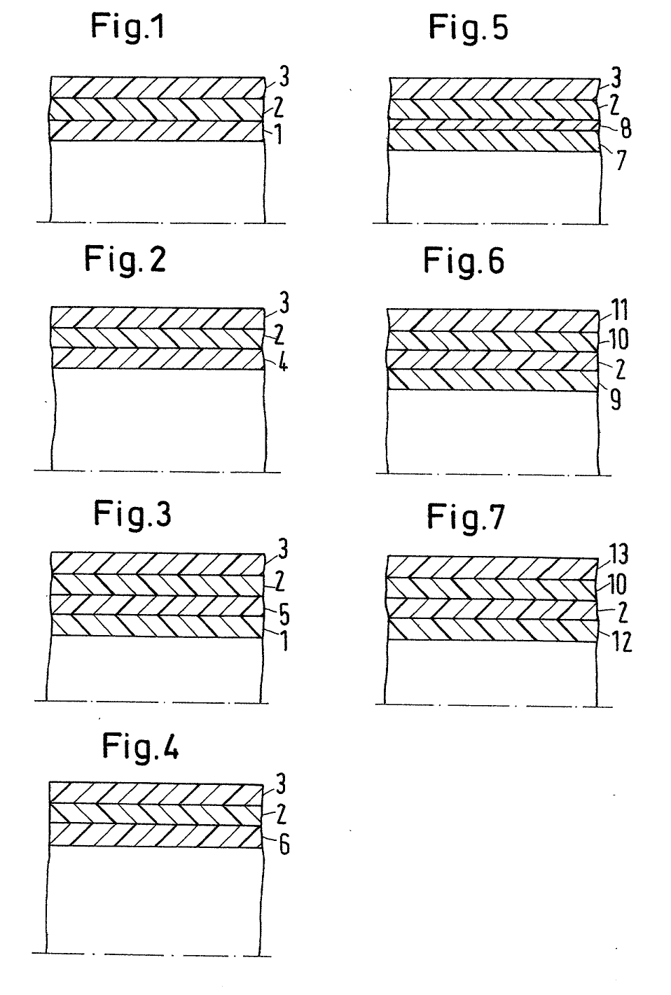

The multilayer pipe according to FIG. 1 contains in an innermost layer 1 a thermoplastic polyester as base material which is mixed with at least one of the materials polyolefin, polyolefin terpolymer and polyolefin copolymer. A middle layer 2 of the multilayer pipe contains a thermoplastic polyester and an outermost layer 3 contains a thermoplastic polyester elastomer..

The innermost layer 1 has a high thermal long-term stability and low brittleness when coming into contact with fuels as they are used for motor vehicles, particularly gasoline, in a temperature range of up to 90° C. and above. The innermost layer 1 simultaneously prevents brittling of the middle layer 2 and of the outermost layer 3 because the innermost layer 1 prevents the layers 2 and 3 from coming into contact with the fuel. Moreover, this multilayer pipe meets the requirements which have to be met in motor vehicles, such as high diffusion-blocking capability, bending capability, extensibility, impact strength, elasticity, resistance to chemicals, and ease of assembly.

In the multilayer pipe according to FIG. 2, the innermost layer 4 is of polyolefin and the middle layer 2 and the outermost layer 3 are each of the same materials as the layers 2 and 3 of the first embodiment.

The multilayer pipe according to FIG. 3 contains in addition to the layers 1, 2 and 3 of the multilayer pipe of FIG. 1 an additional layer 5 of a thermoplastic polyesterelastomer between the innermost layer 1 and the middle layer 2. Alternatively, the layer 1 may also contain only polyolefin.

In the multilayer pipe according to FIG. 4, the innermost layer 6 is composed of a mixture of a polyamid as the base material with at least one of the materials polyolefin, polyolefin copolymer or polyolefin terpolymer. Once again, the middle layer 2 and the outermost layer 3 are of the same materials as the layers 2 and 3 of the first embodiment of FIG. 1.

The embodiment of FIG. 4 also provides the same advantages as those provided by the embodiments of FIGS. 1 through 3, with the exception that polyamid additionally ensures an even higher permeation-blocking capability and resistance to chemicals.

The multilayer pipe according to FIG. 5 once again is composed of the same layers 2 and 3 as the preceding multilayer pipes according to FIGS. 1 through 4. However, the innermost layer 7 either contains a polyamid or the same polyamid mixture as the layer 6 of FIG. 4, wherein the layer 7 is connected to the middle layer 2 through a bonding agent layer 8.

The multilayer pipe according to FIG. 6 once again contains the same layer 2 as the preceding embodiments, while the innermost layer 9 contains a mixture of a thermoplastic polyester as base material with at least one of the materials polyolefin, polyolefin coplymer or polyolefin terpolymer. The middle layer 10 also contains a thermoplastic polyester, as is the case in layer 3 of the preceding embodiments. An additional outermost layer 11 contains a mixture of a thermoplastic polyester as base material with one of the materials polyolefin, polyolefin copolymer and polyolefin terpolymer. The layers 9 and 11 protect the middle layers 2 and 10 against brittling due to contact with fuels, either from the inside or from the outside.

As is the case in the multilayer pipe according to FIG. 6, the multilayer pipe according to FIG. 7 also is composed of four layers, wherein the two middle layers 2 and 10 contain the same materials as the middle layers 2 and 10 of the multilayer pipe according to FIG. 6, while the innermost layer 12 contains at least one of the materials polyolefin, polyolefin terpolymer, polyolefin copolymer and a grafted polyolefin or a mixture of a thermoplastic polyester with a polyolefin or a polyamid mixture as is the case in the layer 7 of FIG. 5. The outermost layer 13 also contains at least one of the materials polyolefin, polyolefin copolymer and polyolefin terpolymer to protect the middle layers against brittling.

In all of the above-described embodiments, at least one of the layers, preferably the innermost layer, may contain an electrically conductive additive, such as carbon particles, particularly soot or graphite powder, or metal particles.

In addition, in all embodiments the material of at least one of the layers is modified to be resistant against thermal aging.

While specific embodiments of the invention have been shown and described in detail to illustrate the inventive principles, it will be understood that the invention may be embodied otherwise without departing from such principles.

I claim:

1. A multilayer pipe comprising at least three layers, wherein at least two of the layers are based on thermoplastic polyester, one of the layers is harder than the other layers, and at least one of the other layers contains a thermoplastic polyesterelastomer, wherein
a radially innermost layer contains at least one of the materials of the group consisting of polyolefin, polyolefin copolymer, polyolefin terpolymer, grafted polyolefin and polyamid, and wherein
at least one of the layers is modified against thermal aging.

2. The multilayer pipe according to claim 1, wherein the thermoplastic polyesterelastomer is a thermoplastic etheresterelastomer.

3. The multilayer pipe according to claim 1, wherein the polyester contains at least one of the materials selected from the group consisting of polybutyleneteraphthalate (PBT), polyethyleneterephthalate (PET), polybutylene-naphthalate (PBN) and polyethylenenaphthalate (PEN).

4. The multilayer pipe according to claim 1, wherein a radially outermost layer contains at least one of the materials selected from the group consisting of polyolefin, polyolefin copolymer, polyolefin terpolymer, grafted polyolefin and polyamid.

5. The multilayer pipe according to claim 1, wherein one of the layers contains an electrically conductive additive.

6. The multilayer pipe according to claim 1, wherein the radially innermost layer contains electrically conductive additive.
